(19) United States
(12) Patent Application Publication
(10) Pub. No.: US 2023/0092484 A1
(43) Pub. Date: Mar. 23, 2023

(54) BLOCK CHAIN-BASED BLOCK CONSENSUS METHOD AND RELATED DEVICE

(71) Applicant: Tencent Technology (Shenzhen) Company Limited, Shenzhen (CN)

(72) Inventors: Qucheng LIU, Shenzhen (CN); Maocai LI, Shenzhen (CN); Zongyou WANG, Shenzhen (CN); Hu LAN, Shenzhen (CN); Gengliang ZHU, Shenzhen (CN); Kaiban ZHOU, Shenzhen (CN); Pan LIU, Shenzhen (CN); Yifang SHI, Shenzhen (CN); Zhiyong LIAO, Shenzhen (CN); Huankun HUANG, Shenzhen (CN)

(73) Assignee: Tencent Technology (Shenzhen) Company Limited, Shenzhen (CN)

(21) Appl. No.: 18/071,271

(22) Filed: Nov. 29, 2022

Related U.S. Application Data
(63) Continuation of application No. PCT/CN2022/080103, filed on Mar. 10, 2022.

(30) Foreign Application Priority Data
Mar. 12, 2021 (CN) 202110273266.3

(51) Int. Cl. G06Q 20/38; G06F 21/60; H04L 9/00; G06Q 20/40

(52) U.S. Cl. CPC G06Q 20/3827; G06F 21/602; H04L 9/50; G06Q 20/401; G06Q 20/3825; G06Q 2220/00

(57) ABSTRACT

In a block chain-based block consensus method, a proposal block generated in an N^{th} round with a block height of M is acquired, and validity verification is performed on the proposal block. An application is executed based on transaction data in the proposal block to obtain a target execution result. A block hash of the proposal block and the target execution result are stored in a memory, including N execution results with the block height of M. While the application is executed based on the transaction data, two rounds of consensus voting processing are performed on the proposal block to obtain a first consensus result. Based on the first consensus result being a consensus pass result, the target execution result mapped by the block hash of the proposal block in the memory is acquired, and the proposal block and the target execution result are stored to a block chain.

### RELATED APPLICATIONS

The present application is a continuation of International Application No. PCT/CN2022/080103, entitled “BLOCK CONSENSUS METHOD BASED ON BLOCKCHAIN, AND RELATED DEVICE” and filed on Mar. 10, 2022, which claims priority to Chinese Patent Application No. 202110273266.3, entitled “BLOCK CHAIN-BASED BLOCK CONSENSUS METHOD AND RELATED DEVICE” and filed on Mar. 12, 2021. The entire disclosures of the prior applications are hereby incorporated by reference in their entirety.

### FIELD OF THE TECHNOLOGY

This application relates to the technical field of computers, including to block chain-based block consensus.

### BACKGROUND OF THE DISCLOSURE

With rapid development of network technology and attention given to data security by governments and enterprises, block chain has received greater attention and has been widely applied. Before a node in the block chain writes a proposal block in the block chain, it is needed to respectively verify the proposal block at first through validator nodes in a consensus network, so as to achieve consensus on the proposal block.

In the related art, a Tendermint (a protocol of byzantine fault tolerant type) consensus protocol is often adopted for block consensus. In the Tendermint consensus protocol, before a proposal block enters a commit phase, it is needed to perform two rounds of voting through the consensus network. Each round of voting needs to be recognized by two-thirds or above of the validator nodes in the consensus network to complete block consensus, and the proposal block enters the commit phase and then executes a contract to obtain a contract execution result. During each round of voting, each validator node needs to broadcast voting information in the consensus network, the consensus phase needs to consume a period of time due to network delay, and execution of the contract will also consume a substantial amount of time. Therefore, the proposal block needs to complete block consensus and then executes the contract. The whole course can take a long time, which results in a low throughput of the block chain.

### SUMMARY

Embodiments of this disclosure provide a block chain-based block consensus method and a related device. The time consumed by block chaining can be shortened and the throughput of the block chain can be improved.

On the one hand, the embodiments of this disclosure provide a block chain-based block consensus method. The method may be executed by a computer device, for example. In the method, a proposal block generated in an N^{th} round with a block height of M is acquired, and validity verification is performed on the proposal block. M and N are both positive integers. An application is executed based on transaction data in the proposal block to obtain a target execution result. A block hash of the proposal block and the target execution result are stored in a memory. The memory includes N execution results with the block height of M. The N execution results include the target execution result. While the application is executed based on the transaction data, two rounds of consensus voting processing are performed on the proposal block to obtain a first consensus result. Based on the first consensus result being a consensus pass result, the target execution result mapped by the block hash of the proposal block in the memory is acquired, and the proposal block and the target execution result are stored to a block chain.

On the one hand, the embodiments of this disclosure provide a block chain-based block consensus apparatus that includes processing circuitry. The apparatus may be deployed on a computer device, for example. The processing circuitry is configured to acquire a proposal block generated in an N^{th} round with a block height of M, and perform validity verification on the proposal block, M and N both being positive integers. The processing circuitry is configured to execute an application based on transaction data in the proposal block to obtain a target execution result, and store a block hash of the proposal block and the target execution result in a memory. The memory includes N execution results with the block height of M. The N execution results include the target execution result. The processing circuity is configured to, while the application is executed based on the transaction data, perform two rounds of consensus voting processing on the proposal block to obtain a first consensus result. Further, the processing circuitry is configured to, based on the first consensus result being a consensus pass result, acquire the target execution result mapped by the block hash of the proposal block in the memory, and store the proposal block and the target execution result to a block chain.

According to another aspect of the embodiments of this disclosure, a computer device is provided, including: a processor and a memory. The processor is connected to the memory, the memory being configured to store a computer program, and the computer program, when executed by the processor, causing the computer device to perform any of the methods according to the embodiments of this disclosure.

According to another aspect of the embodiments of this disclosure, a non-transitory computer-readable storage medium is provided, storing instructions which when executed by a processor cause the processor to perform any of the methods according to the embodiments of this disclosure.

According to another aspect of the embodiments of this disclosure, a computer program product or a computer program is provided, the computer program product or the computer program including computer instructions, the computer instructions being stored in a computer-readable storage medium. A processor of a computer device reads the computer instructions from the computer-readable storage medium, and executes the computer instructions, to cause the computer device to perform any of the methods according to the embodiments of this disclosure.

In an embodiment of this disclosure, after the proposal block generated in the N^{th} round with the block height of M is acquired, the transaction data in the proposal block is executed through the smart contract to obtain the target contract execution result, and the block hash of the proposal block and the target contract execution result are cached to the temporary list in the associated manner; in the process of executing the transaction data through the smart contract, two rounds of consensus voting processing are performed on the proposal block to obtain the first consensus result; and in a case that the first consensus result is a consensus pass result, the target contract execution result mapped by the block hash of the proposal block is acquired in the temporary list, and the proposal block and the target contract execution result are stored to a block chain in the associated manner. M and N both are positive integers. The temporary list includes N contract execution results with the block height of M, and the N contract execution results includes the target contract execution result. By adopting the method provided by the embodiments of this disclosure, execution of the contract and two rounds of voting of the block are parallelly processed, so that the time of storing the proposal block passing consensus and the target contract execution result to the block chain in the associated manner can be shortened, that is, the chaining efficiency of the block is improved, and therefore, the throughput of the chain block can be effectively improved.

### BRIEF DESCRIPTION OF THE DRAWINGS

To describe technical solutions of embodiments of this disclosure more clearly, the following briefly introduces the accompanying drawings for describing the embodiments. The accompanying drawings in the following description show only some embodiments of this disclosure. Other embodiments are within the scope of the present disclosure.

FIG. 1 is a schematic structural diagram of a block chain node system provided by an embodiment of this disclosure.

FIG. 2a to FIG. 2b are schematic scenario diagrams of block consensus provided by an embodiment of this disclosure.

FIG. 3 is a schematic flowchart of a block chain-based block consensus method provided by an embodiment of this disclosure.

FIG. 4 is a schematic scenario diagram of block validity verification provided by an embodiment of this disclosure.

FIG. 5 is a schematic scenario diagram of contract execution provided by an embodiment of this disclosure.

FIG. 6a to FIG. 6b are schematic scenario diagrams of consensus voting provided by an embodiment of this disclosure.

FIG. 7 is a schematic diagram of a process of block consensus provided by an embodiment of this disclosure.

FIG. 8 is a schematic diagram of storage of a contract execution result provided by an embodiment of this disclosure.

FIG. 9 is a schematic structural diagram of a block consensus apparatus provided by an embodiment of this disclosure.

FIG. 10 is a schematic structural diagram of a computer device provided by an embodiment of this disclosure.

### DESCRIPTION OF EMBODIMENTS

Technical solutions in exemplary embodiments of this disclosure are described below with reference to the accompanying drawings in the embodiments of this disclosure. The described embodiments are merely some rather than all of the embodiments of this disclosure. Other embodiments are within the scope of this disclosure.

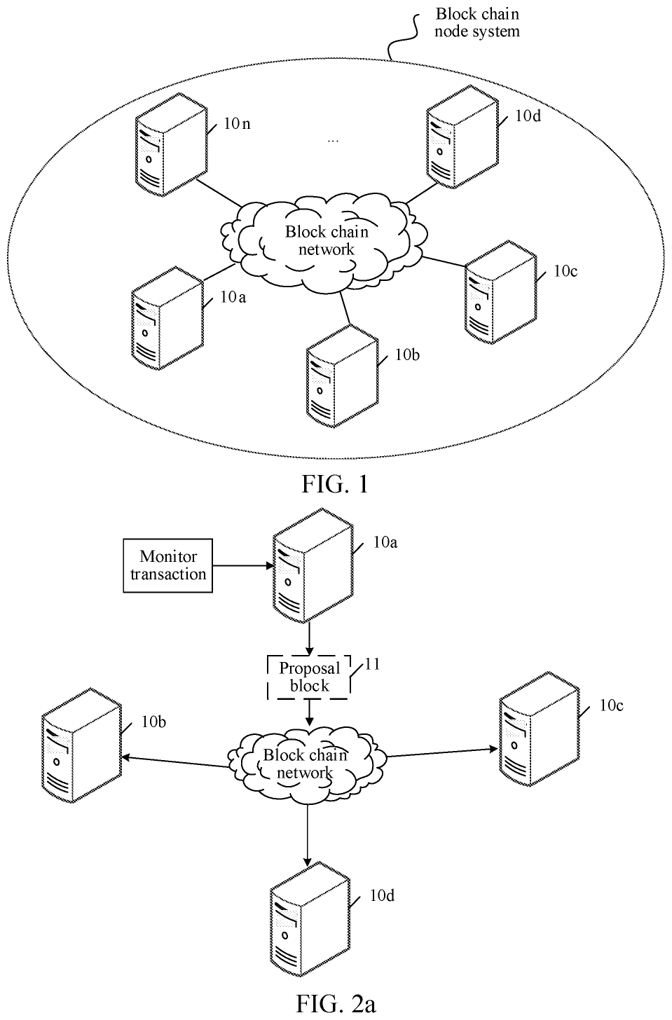

Referring to FIG. 1, FIG. 1 is a schematic structural diagram of a block chain node system provided by an embodiment of this disclosure. Block chain is an application mode of computer technologies such as distributed data storage, point-to-point transmission, consensus mechanism and encryption algorithm, and is mainly used for sorting data in a chronological order and encrypting the data into a ledger, so that the data cannot be tampered or falsified. Meanwhile, the data can be verified, stored and updated. Block chain is essentially a decentralized database. Each node in the database stores the same block chain. A block chain network includes validator nodes, and the validator nodes are responsible for consensus of the whole block chain network.

It is to be understood that a block is a data packet that carries transaction data (that is, transaction) on the block chain network, and is a data structure identified by a timestamp and a hash value of a previous block. The block is verified through the consensus mechanism of the network and transaction in the block is determined.

It is to be understood that the block chain system can include a smart contract. The smart contract can refer to a code capable of being understood and executed by each node (including the validator node) of the block chain, can execute any logic and obtain a result. It is to be understood that the block chain can include one or more smart contracts, and these smart contracts can be differentiated through identity documents (ID) or names. A transaction request can carry the IDs or names of the smart contracts, thereby appointing the smart contracts needed to be operated by the block chain.

The block chain node system shown in FIG. 1 can correspond to the block chain network, and the block chain network can include, but is not limited to, a block chain network corresponding to an alliance chain. The block chain node system refers to a system configured to share data among the block chain nodes. The block chain node system can include a plurality of nodes. The plurality of nodes, for example, can include a node 10a, a node 10b, a node 10c, a node 10d . . . and a node 10n. The node 10a, the node 10b, the node 10c, the node 10d . . . and the node 10n herein can be collectively called block chain nodes. Each node can receive data transmitted from outside during normal work and perform block chaining processing based on the received data, and can also transmit data to the outside. In order to guarantee data intercommunication among the nodes, there can be data connections among the nodes. For example, there is a data connection between the node 10a and the node 10b, there is a data connection between the node 10a and the node 10c, and there is a data connection between the node 10b and the node 10c.

It is to be understood that the nodes can transmit data or blocks through the above-mentioned data connections. The block chain network can realize the data connection among the nodes based on node identifiers. Each node in the block chain network has a corresponding node identifier. Each of the above-mentioned nodes can store the node identifiers of other nodes having connecting relations with the node, so that the acquired data or the generated blocks can be broadcasted to other nodes subsequently according to the node identifiers of other nodes. For example, the node 10a can maintain a node identifier list as shown in Table 1, and the node identifier list stores the node names and the node identifiers of other nodes.

TABLE 1

| Node name | Node identifier |
|---|---|
| Node 10a | 117.114.151.174 |
| Node 10b | 117.116.189.145 |
| Node 10c | 117.114.151.183 |
| Node 10d | 117.117.125.169 |
| . . . | . . . |
| Node 10n | 117.116.189.125 |

The node identifier can be an Internet protocol (IP) address and any other type of information that can be used for identifying the node in the block chain network. Table 1 only uses the IP address as an example for description. For example, the node 10a can transmit information (for example, block) to the node 10b through the node identifier 117.116.189.145, and the node 10b can determine that the information is transmitted by the node 10a through the node identifier

It is to be understood that the above-mentioned data connection does not define the connecting mode, and the above-mentioned data connection can be a direct or indirect connection by way of wired communication, or direct or indirect connection by way of wireless communication, or connection by other connecting modes, which is not limited in this disclosure.

It is to be understood that the block consensus method provided by the embodiments of this disclosure can be executed by a computer device, and the computer device includes, but is not limited to, the above-mentioned validator nodes (the validator nodes can be terminals or servers). The server may be an independent physical server, or may be a server cluster comprising a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal may be a smartphone, a tablet computer, a notebook computer, a desktop computer, a smart speaker, a smartwatch, or the like, but is not limited thereto.

As shown in FIG. 1, in the block chain, before a block (namely, a proposal block) is chained, the block has to be subjected to consensus through the validator nodes in the block chain network, and can be added to the block chain after consensus passes. It is to be understood that when the block chain is used in some scenarios such as government or commercial institutions, not all participating nodes (the block chain nodes in the above-mentioned block chain node system) in the block chain have enough resources and necessity to become the validator nodes of the block chain. For example, in the block chain node system shown in FIG. 1, the node 10a, the node 10b, the node 10c and the node 10d can be taken as the validator nodes in the block chain node system. The validator nodes in the block chain node system participate in the consensus, that is, perform consensus on the block (including a batch of transactions), including generating the proposal block and voting the proposal block; and the non-validator nodes do not participate in the consensus but will help propagation of block and voting messages, as well as mutual state synchronization and the like.

In one round of consensus, a certain node in the validator nodes can be taken as a proposer node to generate the proposal block, and the proposal block is respectively transmitted to other validator nodes in the block chain node system according to the node identifiers of other validator nodes in the block chain node system. Upon receiving the proposal block, each validator node will verify the validity of the proposal block. If the proposal block is valid, the validator node will execute the transaction data in the proposal block according to the smart contract to obtain the target contract execution result, and then cache the target contract execution result; in the process of executing the transaction data through the smart contract, the validator nodes will perform two rounds of consensus voting processing on the proposal block. If two-thirds or above of the validator nodes vote affirmative votes to the proposal block in both of the two rounds of consensus voting processing, it is considered that consensus passes. Then the validator nodes will add the proposal block and the target contract execution result together to the block chain stored thereby. The proposer node is also the validator node, and also needs to perform two rounds of consensus voting processing on the proposal block.

For example, description is made in a case that the proposer node is the node 10a, the node 10a generates the proposal block, and then the node 10a broadcasts the proposal block to other validator nodes, that is, the node 10b, the node 10c and the node 10d, and the nodes jointly perform consensus on the proposal block.

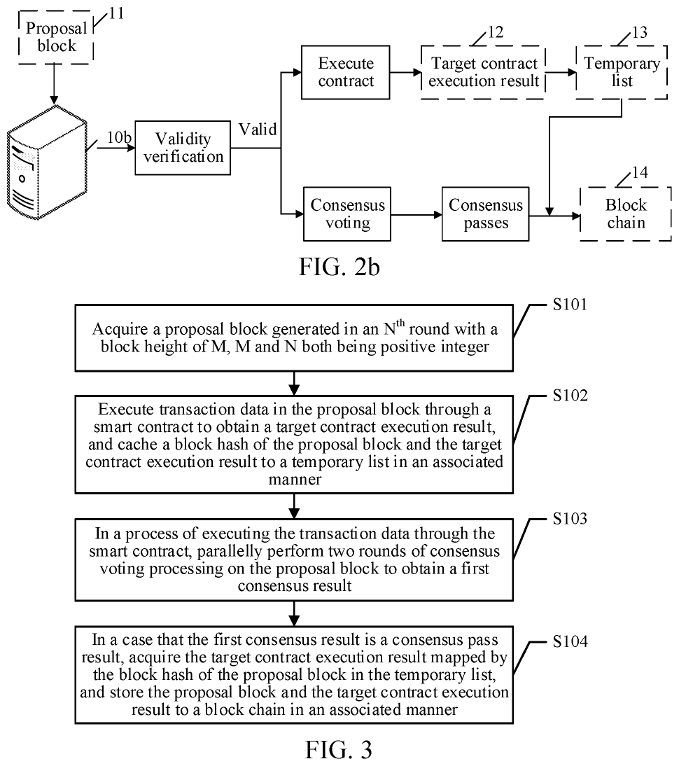

To facilitate understanding, further, referring to FIG. 2a to FIG. 2b, FIG. 2a to FIG. 2b are schematic scenario diagrams of block consensus provided by an embodiment of this disclosure.

As shown in FIG. 2a, the node 10a, as the proposer node, will monitor transactions of the whole block chain network, then collect all transactions and assemble and generate a proposal block 11 according to transaction data corresponding to the collected transactions. Before the proposal block 11 is stored to the block chain, it is needed to be subjected to two rounds of consensus voting processing through the validator nodes in the consensus network, and the proposal block can be stored to the block chain after consensus passes. Therefore, the node 10a will firstly broadcast the proposal block 11 to other validator nodes in the consensus network, that is, the node 10b, the node 10c and the node 10d. All the validator nodes in the consensus network will perform two rounds of consensus voting processing on the proposal block 11. The process of the two rounds of consensus voting processing can be as follows: in the first round of consensus voting, each validator node performs prevote processing on the proposal block 11 according to validity of the proposal block 11 to obtain a prevote result for the proposal block 11, broadcasts its own prevote result to the rest of validator nodes in the consensus network, and receives the prevote results for the proposal block 11 from the rest of validator nodes at the same time; in the second round of consensus voting, each validator node performs precommit processing on the proposal block 11 according to all the obtained prevote results (that is, performs consensus voting again based on the prevote results) to obtain a precommit result for the proposal block 11, broadcasts its own precommit result to the rest of validator nodes in the consensus network, and receives the precommit results for the proposal block 11 from the rest of validator nodes at the same time. Each prevote result can include a first affirmative result or a first negative result, the first affirmative result represents that the validator node determines that the proposal block 11 is valid, and the first negative result represents that the validator node determines that the proposal block 11 is invalid. Each precommit result can include a second affirmative result or a second negative result, the second affirmative result represents that two-thirds or above of the validator nodes vote for the first affirmative result in the prevote results obtained by the validator nodes, and the second negative result represents that one-third or above of the validator nodes vote for the first negative result in the prevote results obtained by the validator nodes. The validator nodes determine that consensus passes according to the obtained precommit results in a case that it is determined that the quantity of the second affirmative results reaches two-thirds of the quantity of the validator nodes in the consensus network, and otherwise, it is determined that consensus fails.

As shown in FIG. 2b, description is made by taking a situation that the node 10b receives the proposal block 11 as an example. After receiving the proposal block 11, the node 10b will perform validity verification on the proposal block 11 to obtain a validity verification result. Validity verification is to verify whether the proposal block 11 is valid, for example, whether the proposal block is generated by the proposer node 10a of this round, whether the data structure and the numerical value in the proposal block 11 are reasonable and the like. After determining that the validity verification result of the proposal block 11 is a valid result, the node 10b will read transaction data in the proposal block 11, and then execute the transaction data in the proposal block 11 through a smart contract to obtain a target contract execution result 12. The target contract execution result 12 can be written in a block chain 14 together with the proposal block 11 only when the consensus network reaches consensus on the proposal block 11. Therefore, the node 10b will firstly store the target contract execution result 12 in a temporary list 13. The temporary list 13 can further store the contract execution results corresponding to other proposal blocks. Therefore, when the target contract execution result 12 is written into the temporary list, the target contract execution result 12 will be associated with a block hash of the proposal block 11. After the proposal block 11 completes consensus, the target contract execution result 12 can be acquired through the block hash of the proposal block 11, and then the proposal block 11 and the target contract execution result 12 are together stored to a block chain 14. The two processes of performing consensus voting on the proposal block 11 and executing the transaction data in the proposal block 11 through the smart contract are simultaneously performed. After receiving the proposal block 11, each validator node in the consensus network will execute the same operation as that of the node 10b, that is, the validator node can simultaneously perform operations of contract execution and block consensus. For specific processes of contract execution and block consensus, reference can be made to description of the embodiment corresponding to FIG. 3 below.

Referring to FIG. 3, FIG. 3 is a schematic flowchart of a block chain-based block consensus method provided by an embodiment of this disclosure. The method can be executed by the validator nodes (for example, the node 10a, the node 10b, the node 10c or the node 10d corresponding to FIG. 2a), and description is made below by taking a situation that the method is executed by the validator nodes as an example. As shown in FIG. 3, the block chain-based block consensus method can include at least the following steps S101-S104.

In step S101, a proposal block generated in an N^{th} round with a block height of M is acquired, M and N both being positive integer.

It is to be understood that the proposal block can also be referred to as an alternative block or a to-be-chained block, which is a block containing transaction data corresponding to each transaction and is assembled and generated after the proposer node monitors and collects all transactions of the whole network within a period of time. The proposer node can be held by a certain validator node in the consensus network and is responsible for proposing the alternative block and broadcasting the alternative block in the network. The proposal block cannot be directly stored to the block chain, needs to be subjected to consensus verification of the consensus network at first, can be chained after consensus passes, and is then connected to a previous block stored in the block chain. Therefore, in short, the block chain is a chain formed by linking the proposal blocks one by one after consensus passes.

Block height is an identifier of the block and is used for measuring a distance from a certain block to the first block in the block chain. The position of the certain block on the chain can be accurately known through the block height, which is equivalent to position a coordinate for the block. Assuming that there are five blocks in the block chain, the block height of the first block is 0, the block height of the second block is 1, . . . and by parity of reasoning, the block height of the fifth block is 4. At the moment, the corresponding block height of the proposal block as a new block prepared to be added into the block chain is 5. As described above, the proposal block cannot be directly stored to the block chain and only can be added into the block chain after block consensus passes. Block consensus can be vote type consensus, that is, after the proposer node in the consensus network generates the proposal block, the validator nodes perform the process of two rounds of consensus voting for the proposal block. For example, block consensus uses a Tendermint consensus algorithm, in a case that two-thirds or above of the validator nodes in both of the two rounds of consensus voting vote for the affirmative votes for the proposal block, it can be considered that consensus for the proposal block passes; and in a case that there are not two-thirds or above of the validator nodes in one of the two rounds of consensus voting vote for the affirmative votes for the proposal block, it can be considered that consensus for the proposal block fails, and the proposal block cannot be stored to the block chain. Assuming that the proposal block with the block height of 5 fails in consensus, a new validator node will be elected in the consensus network to serve as a new proposer node, then the new proposer node will generate a new proposal block, and the consensus network will perform block consensus for the new proposal block. It is to be understood that the block height of the new proposal block is still 5. For differentiation, the proposal block failing in consensus can be referred to as the proposal block generated in the first round with the block height of 5, and the new proposal block is referred to as the proposal block generated in the second round with the block height of 5. In a case that the proposal block generated in the second round with the block height of 5 still fails in consensus, a next proposal block is the proposal block generated in the third round with the block height of 5. The proposer node in each round is elected by an election algorithm (for example, generated in turn) and is not always constant.

In one possible implementation, after receiving the proposal block, the validator nodes will perform validity verification on the proposal block to obtain the validity verification result. Validity verification can be either verification of identity of the proposer node or verification of content of the proposal block.

In one embodiment, to perform validity verification on the proposal block to obtain the validity verification result the validator node may acquire the transaction data in the proposal block, and perform hash operation on the transaction data to obtain a to-be-verified hash value; perform hash operation on the to-be-verified hash value according to a Merkle tree path in the proposal block to obtain a to-be-verified tree root hash value; acquire a Merkle tree root hash value from a header of the proposal block; in a case that the to-be-verified tree root hash value is identical with the Merkle tree root hash value, determine that the validity verification result of the proposal block is a valid result; and in a case that the to-be-verified tree root hash value is not identical with the Merkle tree root hash value, determine that the validity verification result of the proposal block is an invalid result. The hash value is also referred to as an information characteristic value or a characteristic value. The hash value is generated by converting input data of any length into a code through a hash algorithm and fixedly outputting the code. Original input data cannot be retrieved by decrypting the hash value, and it is a unidirectional encryption function. The Merkle tree is composed of a root node, a group of intermediate nodes and a group of leaf nodes. The leaf nodes include storage data or hash values thereof, the intermediate nodes are hash values of contents of two child nodes thereof, and the root node is composed of hash values of contents of two sub nodes thereof. Therefore, the Merkle tree is also referred to as a hash tree.

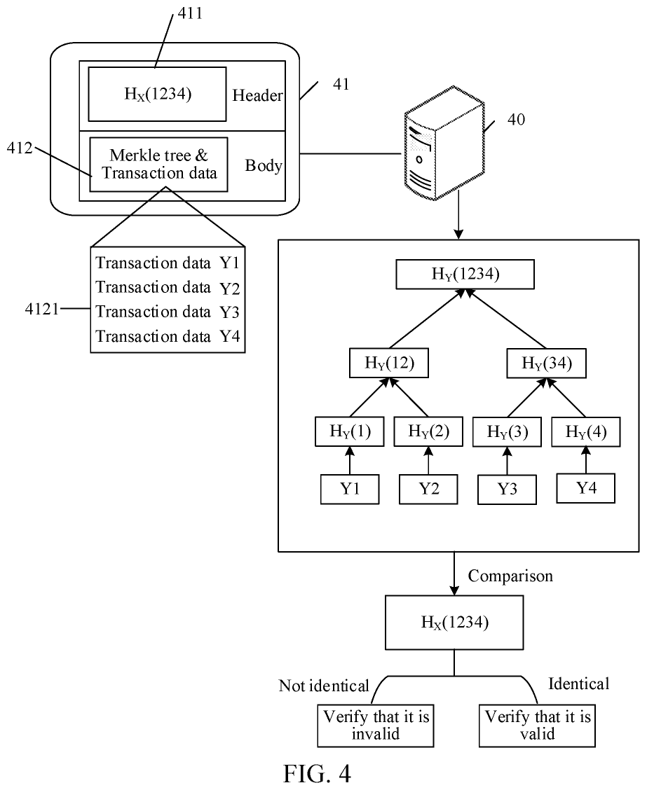

For the convenience of understanding, referring to FIG. 4 together, FIG. 4 is a schematic scenario diagram of block validity verification provided by an embodiment of this disclosure. As shown in FIG. 4, a validator node 40 (any validator node shown in FIG. 2a) receives a proposal block 41, and the proposal block 41 includes two parts of a header 411 and a body 412. There is a Merkle tree root hash value HX (1234) in the header 411. Of course, during actual application, the header 411 can store basic data such as version number, timestamp and difficulty value, and can further store other related data. The Merkle tree and transaction data 4121 are stored in the body 412. The transaction data 4121 includes transaction data Y1, transaction data Y2, transaction data Y3 and transaction data Y4. Each transaction data corresponds to one transaction. Actually, the previous proposal block may include the transaction data corresponding to a plurality of transactions. As shown in FIG. 4, the validator node 40 firstly performs hash calculation on the transaction data Y1, the transaction data Y2, the transaction data Y3 and the transaction data Y4 respectively to obtain a to-be-verified hash value HY (1) of the transaction data Y1, a to-be-verified hash value HY (2) of the transaction data Y2, a to-be-verified hash value HY (3) of the transaction data Y3 and a to-be-verified hash value HY (4) of the transaction data Y4; then the validator node will perform hash operation on these to-be-verified hash values according to the Merkle tree path, that is, perform hash operation on the to-be-verified hash value HY (1) and the to-be-verified hash value HY (2) to obtain a to-be-verified hash value HY (12) including the above-mentioned two to-be-verified hash values, and perform hash operation on the to-be-verified hash value HY (3) and the to-be-verified hash value HY (4) to obtain a to-be-verified hash value HY (34) including the above-mentioned two to-be-verified hash values; and then the validator node finally performs hash operation on the to-be-verified hash value HY (12) and the to-be-verified hash value HY (34) to obtain a to-be-verified tree root hash value HY (1234) including the to-be-verified hash value HY (12) and the to-be-verified hash value HY (34). Then the validator node 40 will compare the to-be-verified tree root hash value HY (1234) with the Merkle tree root hash value HX (1234) in the header 411, in a case that the two are identical, it can be determined that the validity verification result of the proposal block 11 is a valid result; and otherwise, it is determined that the validity verification result of the proposal block 11 is an invalid result.

In one embodiment, to perform validity verification on the proposal block to obtain the validity verification result the validator node may acquire the transaction data in the proposal block; call a transaction verification function to verify the transaction data to obtain a transaction verification result; in a case that the transaction verification result is a valid result, determine that the validity verification result of the proposal block is a valid result; and in a case that the transaction verification result is an invalid result, determine that the validity verification result of the proposal block is an invalid result. The transaction verification function is set according to a calibration standard rule, for example a Check function. Through the Check function, whether grammar of the data structure of the block is valid, whether the block size is within a length limit range, whether the timestamp of the block is two hours early than a verification moment in the future and whether the signature data in the block is less than the upper limit of the signature operation can be verified. In a case that the data format, size, signature and the like of the block comply with the calibration standard rule, the Check function can return 0, i.e., a valid transaction verification result, and at the moment, the validator node will determine that the validity verification result of the proposal block is the valid result, and in a case that the Check function is called to return other values, the validator node will determine that the validity verification result of the proposal block is the invalid result.

In one embodiment, to perform validity verification on the proposal block to obtain the validity verification result the validatory node may acquire a block hash of a parent block of the proposal block in the block chain as a target parent block hash; acquire a parent block hash from the header of the proposal block as a to-be-verified parent block hash; in a case that the to-be-verified parent block hash is identical with the target parent block hash, determine that the validity verification result of the proposal block is a valid result; and in a case that the to-be-verified parent block hash is not identical with the target parent block hash, determine that the validity verification result of the proposal block is an invalid result. The block hash is also an identifier of the block and is calculated through the hash algorithm after splicing three fields of the parent block hash, the block content and the block creation time. The parent block is the previous block of a certain block in the block chain. For example, the parent block of the block with the block height of 5 is the block with the block height of 4.

In one embodiment, to perform validity verification of the proposal block to obtain the validity verification result the validator node may acquire signature data associated with the proposal block; acquire a public key of the proposer node, and verify the signature data through the public key to obtain a signature verification result; in a case that the signature verification result shows successful signature verification, determine that the validity verification result of the proposal block is a valid result; and in a case that the signature verification result shows failed signature verification, determine that the validity verification result of the proposal block is an invalid result. The signature data with successful signature verification is obtained by signing, by the proposer node, the proposal block through a possessed private key. The public key and the private key are commonly known asymmetrical encryption modes. The public key is for public, that is to say, other validator nodes can acquire the public key of the proposer node, while the private key is private, and other validator nodes cannot acquire the private key of the proposer node. The proposer node uses its own private key to process the proposal block. Since the private key is only possessed by the proposer node, documents which cannot be generated by other nodes are generated, that is, digital signatures are formed. In one round of validation, the validator node can know which is the proposer node that generates the proposal block in this round, acquire the public key of the proposer node and then decrypt the signature data through the public key, that is, signature verification. Successful signature verification indicates that the signature data is transmitted by the proposer node, the proposal block associated with the signature data is the proposal block generated by the proposer node in this round of validation rather than the proposal block mistakenly transmitted by other nodes or other invalid blocks, and it can be determined that the validity verification of the proposal block passes; and otherwise, it is determined that the validity verification of the proposal block fails.

The validity verification method for the proposal block mentioned in the above-mentioned one or more embodiments can be used while verifying the validity of the proposal block.

In step S102, transaction data in the proposal block is executed through a smart contract to obtain a target contract execution result, and a block hash of the proposal block and the target contract execution result is cached to a temporary list in an associated manner. In an example, an application is executed based on transaction data in the proposal block to obtain a target execution result, and a block hash of the proposal block and the target execution result are stored in a memory. The memory includes N execution results with the block height of M, the N execution results including the target execution result.

When it is necessary to perform validity verification on the proposal block to obtain the validity verification result, an implementation mode of S102 can be as follows: in a case that the validity verification result is the valid result, execute the transaction data in the proposal block through the smart contract to obtain the target contract execution result.

After acquiring the proposal block and verifying that the proposal block is valid, the validator node will call the transaction execution function in the smart contract for executing the transaction data, then acquire read data for the transaction data through the transaction execution function and then execute the transaction execution function through the read data and the transaction data to obtain the target contract execution result. Then the validator node will acquire the block hash of the proposal block and cache the block hash of the proposal block and the target contract execution result to the temporary list in the associated manner. The smart contract is a computer protocol intended to propagate, verify or execute a contract in an informatization mode. In the block chain system, the smart contract is a code capable of being understood and executed by each node of the block chain, can execute any logic and obtain a result. During actual application, the smart contract is managed and tried through transaction on the block chain. The transaction data corresponding to each transaction is equivalent to a remote procedure call (RPC) request to the block chain system. In a case that the smart contract is equivalent to an executable program, the block chain is equivalent to an operating system that provides an operating environment. The block chain can include a plurality of contracts, and the contracts are differentiated with identities (ID), identity documents or names.

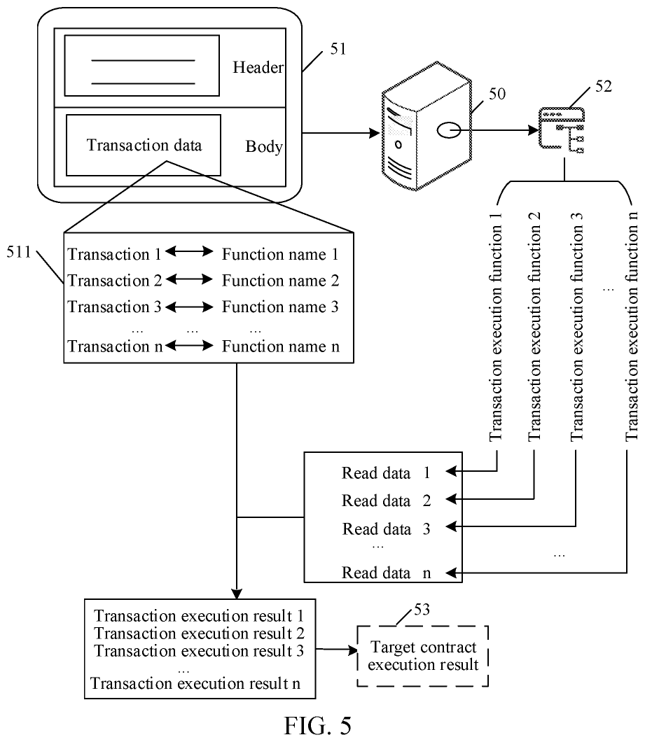

For the convenience of understanding, referring to FIG. 5 together, FIG. 5 is a schematic scenario diagram of contract execution provided by an embodiment of this disclosure. As shown in FIG. 5, a validator node 50 (any validator node shown in FIG. 2a) acquires a proposal block 51, where the proposal block 51 can be a block to be subjected to consensus generated by the proposer node in the consensus network. The body of the proposal block 51 includes transaction data 511, and the transaction data 511 can include a transaction 1, a transaction 2, a transaction 3 . . . and a transaction n, and function names corresponding to the transactions. The validator node 50 can call the transaction execution function in a smart contract 52 for executing the transaction data according to the function names. As shown in FIG. 5, the function for executing the transaction 1 is the transaction execution function 1, the function for executing the transaction 2 is the transaction execution function 2, the function for executing the transaction 3 is the transaction execution function 3 . . . and the function for executing the transaction n is the transaction execution function n. It is to be understood that the functions (including the functions respectively corresponding to the function name 1, the function name 2, the function name 3 . . . and the function name n) can be either called in the same smart contract or called in different smart contracts. For example, the function (the transaction execution function 1) corresponding to the function name 1 and the function (the transaction execution function 2) corresponding to the function name 2 are called in a smart contact B, and the function (the transaction execution function 3) corresponding to the function name 3 and the function (the transaction execution function n) corresponding to the function name n are called in a smart contact V.

Then the validator node 50 can acquire historical transaction data for the transaction data according to the transaction execution function and determine the historical transaction data as the read data. As shown in FIG. 5, read data 1 of the transaction 1 is acquired through the transaction execution function 1, read data 2 of the transaction 2 is acquired through the transaction execution function 2, read data 3 of the transaction 3 is acquired through the transaction execution function 3, and read data n of the transaction n is acquired through the transaction execution function n. For example, the transaction 1 is that a party A transfers 10 yuan to a party B through his/her own account, the transaction execution function 1 is a transfer execution function, the read data 1, namely the historical transaction data of the transaction 1 is that 20 yuan is left in the account of the party A, and the transaction execution result 1 for the transaction 1 can be 20−10=10 yuan, that is, after the transaction 1 is executed, 10 yuan is left in the account of the party A.

Taking the transaction 1 briefly as an example above, a relation among the transaction data, the read data and the transaction execution results is narrated, so that the transaction execution result 2 of the transaction 2 can be obtained according to the transaction 2, the read data 2 and the transaction execution function 2; the transaction execution result 3 of the transaction 3 can be obtained according to the transaction 3, the read data 3 and the transaction execution function 3; . . . ; and the transaction execution result n of the transaction n can be obtained according to the transaction n, the read data n and the transaction execution function n. The validator node will take the transaction execution result 1, the transaction execution result 2, the transaction execution result 3 . . . and the transaction execution result n as the target contract execution results, then establish an incidence relation between the target contract execution results and the block hash of the proposal block, and cache the incidence relation to the temporary list.

In the embodiments of this disclosure, the temporary list can further store the contract execution results corresponding to other proposal blocks, and how many proposal blocks in the proposal blocks generated in previous N rounds execute the transaction data, how many contract execution results can be obtained. In a case that the proposal blocks generated in previous N rounds all execute the transaction data, the temporary list includes N contract execution results with the block height of M, and the N contract execution results include the target contract execution result.

In step S103, in a process of executing the transaction data through the smart contract, two rounds of consensus voting processing are parallelly performed on the proposal block to obtain a first consensus result. In an example, while the application is executed based on the transaction data, two rounds of consensus voting processing are performed on the proposal block to obtain a first consensus result.

Contract execution and two rounds of consensus voting processing are performed parallelly, that is to say, when starting to perform consensus voting to the proposal block, the validator node simultaneously executes the transaction data through the smart contract. In the first round of consensus voting, the validator node performs prevote processing on the proposal block according to the validity verification result of the proposal block to obtain a prevote result; and in the second round of consensus voting, the validator node performs precommit processing on the proposal block according to the prevote result to obtain the first consensus result.

In the first round of consensus voting, to perform prevote processing on the proposal block according to the validity verification result of the proposal block to obtain a prevote result the validator node may in the first round of consensus voting, since the validator node has determined the validity of the proposal block, determine the first prevote result as a first affirmative result for the proposal block; broadcast the first prevote result to a plurality of target validator nodes; receive second prevote results respectively transmitted by the plurality of target validator nodes; determine the quantity of first affirmative votes and the quantity of first negative votes for the proposal block according to the first prevote result and the plurality of second prevote results; in a case that the quantity of first affirmative votes exceeds a first prevote threshold, determine that the prevote result is a successful prevote result; and in a case that the quantity of first negative votes exceeds a second prevote threshold, determine that the prevote result is a failed prevote result. There is the first affirmative result for the proposal block in the plurality of second prevote results, or there is a first negative result for the proposal block in the plurality of second prevote results. The first prevote threshold can be two-thirds of the total quantity of the validator nodes in the consensus network, for example, if the total quantity of the validator nodes is 30, the first prevote threshold can be 20; and the second prevote threshold can be one-third of the total quantity of the validator nodes in the consensus network, for example, if the total quantity of the validator nodes is 30, the second prevote threshold can be 10.

In the second round of consensus voting, to perform precommit processing on the proposal block according to the prevote result to obtain the first consensus result the validator node may in a case that the validator node determines that the prevote result is the successful prevote result in the first round of consensus voting, determine a first precommit result as a second affirmative result for the proposal block; otherwise, the validator node determines the first precommit result as a second negative result for the proposal block; then the validator node will broadcast the first precommit result to the plurality of target validator nodes; meanwhile, the validator node will receive second precommit results respectively transmitted by the plurality of target validator nodes; determine the quantity of second affirmative votes and the quantity of second negative votes for the proposal block according to the first precommit result and the plurality of second precommit results; in a case that the quantity of second affirmative votes exceeds a first precommit threshold, determine that the first consensus result is a consensus pass result; and in a case that the quantity of second negative votes exceeds a second precommit threshold, determine that the first consensus result is a consensus fail result. There is the second affirmative result for the proposal block in the plurality of second precommit results, or there is a second negative result for the proposal block in the plurality of second precommit results. The first precommit threshold can be two-thirds of the total quantity of the validator nodes in the consensus network, for example, if the total quantity of the validator nodes is 30, the first precommit threshold can be 20; and the second precommit threshold can be one-third of the total quantity of the validator nodes in the consensus network, for example, if the total quantity of the validator nodes is 30, the second precommit threshold can be 10.

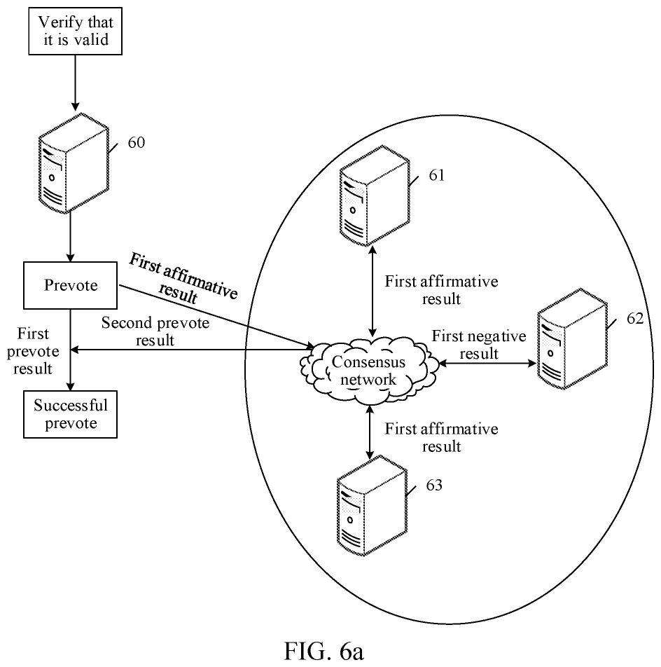

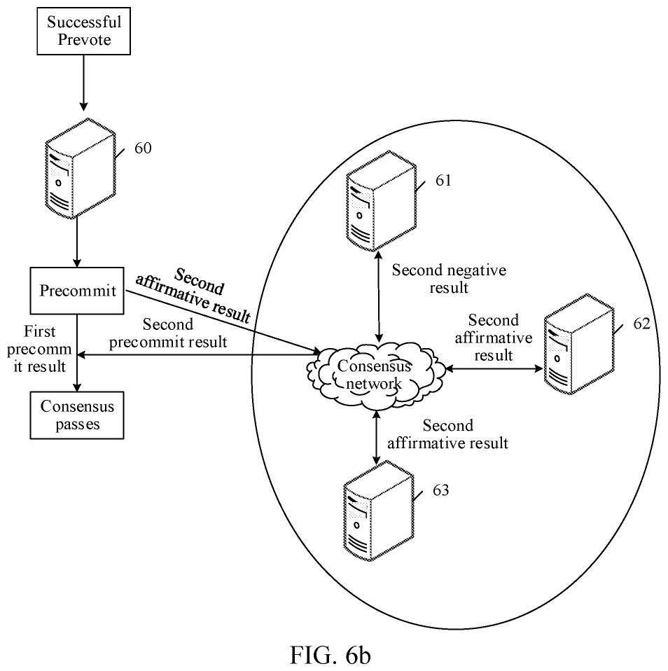

For the convenience of understanding, referring to FIG. 6a to FIG. 6b together, FIG. 6a to FIG. 6b are schematic scenario diagrams of consensus voting provided by an embodiment of this disclosure. As shown in FIG. 6a, after verifying that the proposal block is valid by a validator node 60 (which can be the node 10a, the node 10b, the node 10c or the node 10d shown in FIG. 2a), the validator node 60 performs first round of consensus voting for the proposal block, that is, prevote processing. Since the validity verification result of the proposal block is the valid result, the validator node 60 determines that the first prevote result for the proposal block is the first affirmative result and then broadcasts the first affirmative result to other validator nodes in the consensus network. It is to be understood that after generating the proposal block, the proposer node will broadcast it to all the validator nodes in the consensus network. Therefore, the validator node 60 is removed, and the rest of validator nodes will execute consensus processing for the proposal block like the validator node 60 after receiving the proposal block. That is to say, a validator node 61, a validator node 62 and a validator node 63 will also perform first round of consensus voting for the proposal block, and then broadcast own prevote results. For the validator node 60, the prevote results of the validator node 61, the validator node 62 and the validator node 63 are the second prevote results. As shown in FIG. 6a, the validator node 60 will receive the first affirmative result of the validator node 61, the first negative result of the validator node 62 and the first affirmative result of the validator node 63. The first negative result is probably the prevote result determined because the validator node 62 has not received the proposal block for a long time due to a network problem or the validator node 62 determines that the validity verification result of the proposal block is invalid. Then, the validator node 60 counts that the quantity of the first affirmative votes is 3 and the quantity of the first negative vote is 1 according to the first prevote result and the received second prevote results of the rest of validator nodes. It is apparent that the quantity of the first affirmative votes is greater than two-thirds of the quantity of all the validator nodes in the consensus network, so that the validator node 60 will determine that the prevote is successful.

As shown in FIG. 6b, after determining that the prevote is successful, the validator node 60 will enter the second round of consensus voting, that is, precommit processing. The precommit processing is actually performed according to the prevote result of the validator node, the prevote result of the validator node 60 is the successful prevote result, and the validator node 60 will determine the first precommit result as the second affirmative result and then broadcasts it to the rest of validator nodes in the consensus network. Similarly, the validator node 60 will receive second precommit results of the rest of validator nodes. The second precommit result can be the second affirmative result, or the second negative result. As shown in FIG. 6b, the validator node 61 may determine that the prevote result is failed prevote due to the network problem or a broadcast transmission problem, so as to determine the second precommmit result as the second negative result. However, the validator node 62, the validator node 63 and the validator node 61 all determine that the prevote result is successful prevote, therefore, they all are second affirmative results. The validator node 60 can determine that the quantity of the second affirmative votes for the proposal block is 3 and the quantity of the second negative vote is 1 according to the first precommit result and the received second precommit result. Therefore, the validator node 60 will determine that the proposal block passes consensus.

Under a possible circumstance, in the above-mentioned two rounds of consensus voting processes, when receiving the second prevote results or the second precommit results of the rest of validator nodes by the validator node 60, the validator node 60 can receive the second prevote results of the rest of validator nodes asynchronously due to reasons of distances between the validator node 60 and the rest of validator nodes and network speed and the like. For example, the validator node 60 can receive the second prevote result transmitted by the validator node 61 10 s after receiving the second prevote result of the validator node 62; and the second precommit result is in the similar way. Therefore, during two rounds of consensus voting processing, the validator node can persistently count the quantities of the affirmative votes or the negative votes according to obtained voting results. As long as the quantity of the affirmative votes reaches two-thirds of the total quantity of the validator nodes, a next action can be performed without waiting for receiving the voting results of all the validator nodes.

In step S104, in a case that the first consensus result is a consensus pass result, the target contract execution result mapped by the block hash of the proposal block in the temporary list is acquired, and the proposal block and the target contract execution result are stored to a block chain in an associated manner. In an example, based on the first consensus result being a consensus pass result, the target execution result mapped by the block hash of the proposal block in the memory is acquired, and the proposal block and the target execution result are stored to a block chain.

After consensus of the proposal block passes, the validator node can acquire the mapped target contract execution result in the temporary list according to the block hash of the proposal block, and then store the proposal block and the target contract execution result to the block chain in an associated manner.

Through the method provided by the embodiments of this disclosure, the validator node acquires the proposal block, then verifies that the proposal block is valid, performs contract execution in the proposal block and consensus voting processing of the proposal block at the same time, and cache the target contract execution result obtained by contract execution to the temporary list. If the consensus result for the proposal block is the consensus pass result, the validator node acquires the target contract execution result cached in the temporary list and stores the target contract execution result together with the proposal block to the block chain. By adopting the method provided by the embodiments of this disclosure, the time consumed by block chaining is shortened and the throughput of the block chain is greatly improved.

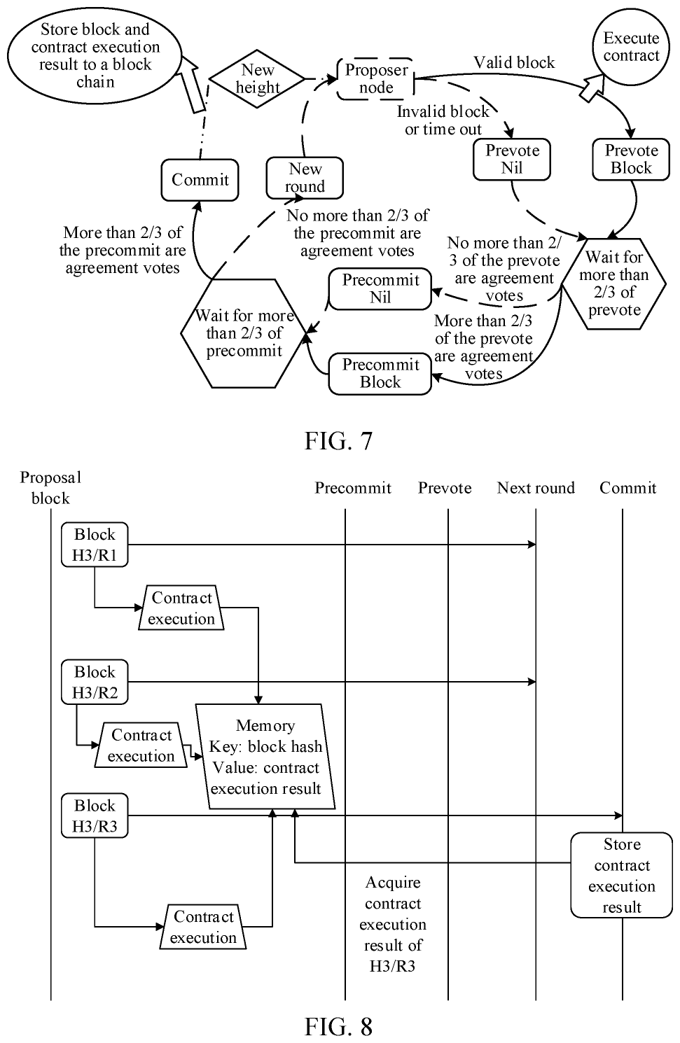

Referring to FIG. 7, FIG. 7 is a schematic diagram of a process of block consensus provided by an embodiment of this disclosure. As shown in FIG. 7, a proposer node starts to monitor and collect all transactions in the whole network, assembles a new block after a period of time, and broadcasts the new block to the whole network. The block is the proposal block. After receiving the proposal block, all the validator nodes in the whole network start to read all transaction data in the proposal block for verification one by one. If there is no problem, it is determined that the proposal block is a valid block, then the validator nodes transmit a prevote block message representing agreement on the proposal block to vote an affirmative vote. Meanwhile, the validator nodes start to execute the transaction data in the proposal block through the smart contract, that is, Execute contract, and caches the obtained target contract execution result; and in a case that the validator nodes do not receive the proposal block or the validator nodes find that there are invalid transactions in the proposal block, it is determined that the proposal block is an invalid block, then the validator nodes transmit a prevote nil message representing disagreement on the proposal block to vote a negative vote.

As shown in FIG. 7, these prevote messages will be broadcasted to all the validator nodes, so that each validator node not only transmits a prevote message, but also collects prevote messages of others. When the validator nodes find that the quantity of the collected prevote messages agreed to vote exceeds ⅔ (more than ⅔ of the prevote are agreement votes) of the total quantity of the validator nodes, the validator nodes will transmit precommit information of a precommit block, which is voting in the second phase. Similarly, each validator node not only transmits a precommit message, but also collects precommit messages of others. When the quantity of the agreement votes in the precommit messages collected by one validator node exceeds ⅔ (more than ⅔ of the precommit are agreement votes) of the total quantity of the validator nodes, it indicates that the proposal block obtains agreement of the majority of validator nodes, then the validator nodes write the proposal block and the cached target contract execution result to a local block chain and add the same to the end to complete commit. Meanwhile, the block height is increased by 1, so that a new height is obtained to enter a next round. The proposer node starts to propose the new block corresponding to the new height. But when the quantity of the agreement votes in the precommit message collected by one validator node does not exceed ⅔ of the total quantity of the validator nodes, in other words, the negative votes in the precommit message collected by the validator node exceeds 1/3 of the total quantity of the validator nodes, it indicates that the proposal block cannot obtain agreement of the majority of validator nodes, and therefore, the validator nodes will not write the proposal block and the cached target contract execution result to the local block chain. Commit fails, and at the moment, the block height will not be changed, and it enters the next round (a new round in FIG. 7). The proposer node starts to propose the new block corresponding to the block height.

It can be known from above that one or more rounds are needed in order to write the current block height in the block chain into a new block. One round includes four phases (steps): Propose, Execute contract, Prevote and Precommit. It can be understood that the Execute contract step and the Prevote and Precommit steps are executed parallelly. The whole block consensus process is composed of one or more rounds in addition to two special phases: Commit and NewHeight, as shown below:

NewHeight→Propose→(Execute contract)/(Prevote→Precommit)}+→Commit→NewHeight→ . . .

In one possible implementation, in a case that the validity verification result of the proposal block is the invalid result, that is, the proposal block is the invalid block, the validator node still performs two rounds of consensus voting processing on the proposal block to obtain a second consensus result; in a case that the second consensus result is the consensus pass result, the proposal block, with the block height of M, that has been stored to the block chain is synchronized from the completed validator node and the target contract execution result corresponding to the proposal block. The completed validator node is the target validator node that successfully stores the proposal block and the target contract execution result to the block chain.

In one possible implementation, in one round, the validator node has not received the proposal block timely due to problems of network and the like, the validator node, of course, will not wait all the time. Therefore, in response to not acquiring the proposal block generated in the N^{th} round with the block height of M within a verification time threshold, the validator node will construct a temporary empty block, and then performs two rounds of consensus voting processing for the temporary empty block to obtain a third consensus result. In a case that the third consensus result is the consensus pass result, and there is no transaction data in the empty block, the validator node will synchronize the proposal block, with the block height of M, that has been stored to the block chain from the completed validator node and the target contract execution result corresponding to the proposal block. The completed validator node is the target validator node that successfully stores the proposal block and the target contract execution result to the block chain. Through the method provided by the embodiments of this disclosure, the contract is executed when it is detected that the proposal block is the valid block, that is, the contract can be executed while broadcasting the prevote information and the precommit information. When the time of executing the contract is equivalent to the time of the two times of broadcasting, the time of executing the contract is equivalently saved, and therefore, the performance of the block chain is greatly improved.

Referring to FIG. 8, FIG. 8 is a schematic diagram of storage of a contract execution result provided by an embodiment of this disclosure. In the embodiments of this disclosure, the validator node executes the contract in the proposal block which may not be committed finally in advance. Therefore, when the contract is executed, the execution result cannot be directly stored to a database, and it is needed to cache the temporary execution result. For example, the execution result is stored in a temporary list in a memory or a temporary list in a temporary database and the like. As shown in FIG. 8, a block H3/R1 refers to the proposal block generated in the first round with the block height of 3, a block H3/R2 refers to the proposal block generated in the second round with the block height of 3, and a block H3/R3 refers to the proposal block generated in the third round with the block height of 3. Probably due to problems of network and the like, consensus voting (for example, precommit and prevote) of the blocks H3/R1 and H3/R2 fails, and the blocks enter the next round. Although the validator node has executed the contracts in the blocks H3/R1 and H3/R2, it will not write the corresponding contract execution results into the block chain. As shown in FIG. 8, after obtaining the contract execution result, the validator node will firstly cache the contract execution result to the temporary list of the memory. It is to be understood that the temporary list may store the contract execution results corresponding to a plurality of proposal blocks. Therefore, the results can be stored by using a [k,v] key-value pair (Key-Value storage, abbreviated for KV storage, key is the number of the stored value and value is the data to be stored), that is, the contract execution result is taken as the value and is associated with a unique key value. The block hash of the proposal block can be used as a key (unique identifier) to store the temporary contract execution result. Then, when the validator node commits the proposal block, it is only needed to find out the contract execution result corresponding to the block hash of the proposal block decided to be committed and store the same into a ledger.

In one possible implementation, after committing the final proposal block with the block height of M, the validator node can delete N contract execution results with the block height of M in the temporary list.

In one possible implementation, the validator node may acquire the total quantity of all the contract execution results in the temporary list, and in a case that the total quantity is greater than or equal to a stored quantity threshold, delete all the contract execution results in the temporary list, where all the contract execution results include the contract execution results respectively corresponding to one or more block heights.

Through the method provided by the embodiments of this disclosure, the contract execution result corresponding to the proposal block is identified by using the block hash. Even if there are a plurality of corresponding proposal blocks with the same block height, when the final proposal block is finally committed, the temporarily cached contract execution result can be found according to the block hash of the final proposal block without storage disorder. Meanwhile, the cached contract execution result is deleted after the proposal block is committed, so that internal memory can be released, and the performance of the block chain is improved.

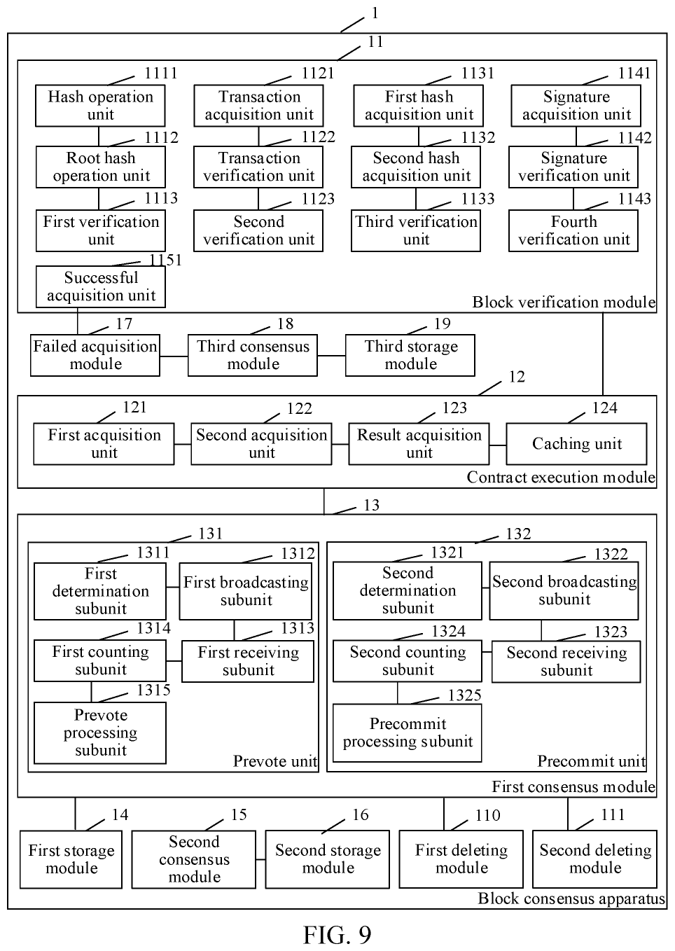

Referring to FIG. 9, FIG. 9 is a schematic structural diagram of a block consensus apparatus provided by an embodiment of this disclosure. A block consensus apparatus 1 can include a block verification module 11, a contract execution module 12, a first consensus module 13 and a first storage module 14. One or more modules, submodules, and/or units of the apparatus can be implemented by processing circuitry, software, or a combination thereof, for example.

The block verification module 11 is configured to acquire a proposal block generated in an N^{th} round with a block height of M, M and N both being positive integers.

The contract execution module 12 is configured to execute transaction data in the proposal block through a smart contract to obtain a target contract execution result, and cache a block hash of the proposal block and the target contract execution result to a temporary list in an associated manner; the temporary list including N contract execution results with the block height of M, the N contract execution results including the target contract execution result.

The first consensus module 13 is configured to, in a process of executing the transaction data through the smart contract, parallelly perform two rounds of consensus voting processing on the proposal block to obtain a first consensus result.

The first storage module 14 is configured to, in a case that the first consensus result is a consensus pass result, acquire the target contract execution result mapped by the block hash of the proposal block in the temporary list, and store the proposal block and the target contract execution result to a block chain in an associated manner.

For exemplary function implementations of the block verification module 11, the contract execution module 12, the first consensus module 13 and the first storage module 14, reference can be made to S101-S104 in the embodiment corresponding to FIG. 3, and details will not be repeated herein.

In one possible implementation, the block verification module 11 is further configured to perform validity verification on the proposal block to obtain a validity verification result.

The contract execution module 12 is configured to in a case that the validity verification result is a valid result, execute the transaction data in the proposal block through the smart contract to obtain the target contract execution result.

In one possible implementation, the temporary list stores the block hash of the proposal block and the target contract execution result through a key-value pair, the block hash of the proposal block being a key in the key-value pair and the target contract execution result being a value in the key-value pair.

Referring to FIG. 9 again, the block verification module 11 can include: a hash operation unit 1111, a root hash acquisition unit 1112 and a first verification unit 1113.

The hash operation unit 1111 is configured to acquire the transaction data in the proposal block, and perform hash operation on the transaction data to obtain a to-be-verified hash value.

The hash operation unit 1111 is further configured to perform hash operation on the to-be-verified hash value according to a Merkle tree path in the proposal block to obtain a to-be-verified tree root hash value.

The root hash acquisition unit 1112 is configured to acquire a Merkle tree root hash value from a header of the proposal block.

The first verification unit 1113 is configured to, in a case that the to-be-verified tree root hash value is identical with the Merkle tree root hash value, determine that the validity verification result of the proposal block is a valid result.

The first verification unit 1113 is further configured to, in a case that the to-be-verified tree root hash value is not identical with the Merkle tree root hash value, determine that the validity verification result of the proposal block is an invalid result.

For exemplary function implementations of the hash operation unit 1111, the root hash acquisition unit 1112 and the first verification unit 1113, reference can be made to the steps of performing validity verification on the proposal block to obtain the validity verification result in the embodiment corresponding to FIG. 3, and details will not be repeated herein.

Referring to FIG. 9 again, the block verification module 11 can include: a transaction acquisition unit 1121, a transaction verification unit 1122 and a second verification unit 1123.

The transaction acquisition unit 1121 is configured to acquire the transaction data in the proposal block.

The transaction verification unit 1122 is configured to call a transaction verification function to verify the transaction data to obtain a transaction verification result.

The second verification unit 1123 is configured to, in a case that the transaction verification result is a valid result, determine that the validity verification result of the proposal block is a valid result.

The second verification unit 1123 is further configured to, in a case that the transaction verification result is an invalid result, determine that the validity verification result of the proposal block is an invalid result.

For exemplary function implementations of the transaction acquisition unit 1121, the transaction verification unit 1122 and the second verification unit 1123, reference can be made to the steps of performing validity verification on the proposal block to obtain the validity verification result in the embodiment corresponding to FIG. 3, and details will not be repeated herein.

Referring to FIG. 9 again, the block verification module 11 can include: a first hash acquisition unit 1131, a second hash acquisition unit 1132 and a third verification unit 1133.

The first hash acquisition unit 1131 is configured to acquire a block hash of a parent block of the proposal block in the block chain as a target parent block hash.

The second hash acquisition unit 1132 is further configured to acquire a parent block hash from the header of the proposal block as a to-be-verified parent block hash.

The third verification unit 1133 is configured to, in a case that the to-be-verified parent block hash is identical with the target parent block hash, determine that the validity verification result of the proposal block is a valid result.

The third verification unit 1133 is further configured to, in a case that the to-be-verified parent block hash is not identical with the target parent block hash, determine that the validity verification result of the proposal block is an invalid result.

For exemplary function implementations of the first hash acquisition unit 1131, the second hash acquisition unit 1132 and the third verification unit 1133, reference can be made to the steps of performing validity verification on the proposal block to obtain the validity verification result in the embodiment corresponding to FIG. 3, and details will not be repeated herein.

Referring to FIG. 9 again, the block verification module 11 can include: a signature acquisition unit 1141, a signature verification unit 1142 and a fourth verification unit 1143.

The signature acquisition unit 1141 is configured to acquire signature data associated with the proposal block.

The signature verification unit 1142 is configured to acquire a public key of a proposer node, and verify the signature data through the public key to obtain a signature verification result.

The fourth verification unit 1143 is configured to, in a case that the signature verification result shows successful signature verification, determine that the validity verification result of the proposal block is a valid result; the signature data with successful signature verification being obtained by signing, by the proposer node, the proposal block through a possessed private key; and the proposal block associated with the signature data with successful signature verification being generated by the proposer node.

The fourth verification unit 1143 is further configured to, in a case that the signature verification result shows failed signature verification, determine that the validity verification result of the proposal block is an invalid result.

For exemplary function implementations of the signature acquisition unit 1141, the signature verification unit 1142 and the fourth verification unit 1143, reference can be made to the steps of performing validity verification on the proposal block to obtain the validity verification result in the embodiment corresponding to FIG. 3, and details will not be repeated herein.

Referring to FIG. 9 again, the contract execution module 12 can include: a first acquisition unit 121, a second acquisition unit 122, a result acquisition unit 123 and a caching unit 124.

The first acquisition unit 121 is configured to acquire the transaction data in the proposal block, and call a transaction execution function for executing the transaction data in the smart contract.

The second acquisition unit 122 is configured to acquire read data for the transaction data according to the transaction execution function.

The result acquisition unit 123 is configured to execute the transaction execution function according to the read data and the transaction data to obtain the target contract execution result of the transaction data.

The caching unit 124 is configured to cache the block hash of the proposal block and the target contract execution result to the temporary list in an associated manner.

For exemplary function implementations of the first acquisition unit 121, the second acquisition unit 122, the result acquisition unit 123 and the caching unit 124, reference can be made to S102 in the embodiment corresponding to FIG. 3, and details will not be repeated herein.

Referring to FIG. 9 again, the first consensus module 13 can include: a prevote unit 131 and a precommit unit 132.

The prevote unit 131 is configured to, in the first round of consensus voting, perform prevote processing on the proposal block according to the validity verification result of the proposal block to obtain a prevote result.

The precommit unit 132 is configured to, in the second round of consensus voting, perform precommit processing on the proposal block according to the prevote result to obtain the first consensus result.

For exemplary functional implementations of the prevote unit 131 and the precommit unit 132, reference can be made to S103 in the embodiment corresponding to FIG. 3, and details will not be repeated herein.

Referring to FIG. 9 again, the prevote unit 131 can include: a first determination subunit 1311, a first broadcasting subunit 1312, a first receiving subunit 1313, a first counting subunit 1314 and a prevote processing subunit 1315.

The first determination subunit 1311 is configured to, in the first round of consensus voting, determine a first prevote result as a first affirmative result for the proposal block according to the valid result.

The first broadcasting subunit 1312 is configured to broadcast the first prevote result to a plurality of target validator nodes.

The first receiving subunit 1313 is configured to receive second prevote results respectively transmitted by the plurality of target validator nodes; there being the first affirmative result for the proposal block in the plurality of second prevote results or there being a first negative result for the proposal block in the plurality of second prevote results.

The first counting subunit 1314 is configured to determine the quantity of first affirmative votes and the quantity of first negative votes for the proposal block according to the first prevote result and the plurality of second prevote results.

The prevote processing subunit 1315 is configured to, in a case that the quantity of first affirmative votes exceeds a first prevote threshold, determine that the prevote result is a successful prevote result.

The prevote processing subunit 1315 is further configured to, in a case that the quantity of first negative votes exceeds a second prevote threshold, determine that the prevote result is a failed prevote result.

For exemplary function implementations of the first determination subunit 1311, the first broadcasting subunit 1312, the first receiving subunit 1313, the first counting subunit 1314 and the prevote processing subunit 1315, reference can be made to specific description in the embodiment corresponding to FIG. 6a, and details will not be repeated herein.

Referring to FIG. 9 again, the precommit unit 132 can include: a second determination subunit 1321, a second broadcasting subunit 1322, a second receiving subunit 1323, a second counting subunit 1324 and a precommit processing subunit 1325.

The second determination subunit 1321 is configured to, in a case that the prevote result is the successful prevote result, determine a first precommit result as a second affirmative result for the proposal block.

The second determination subunit 1321 is further configured to, in a case that the prevote result is the failed prevote result, determine the first precommit result as a second negative result for the proposal block.

The second broadcasting subunit 1322 is configured to broadcast the first precommit result to a plurality of target validator nodes.

The second receiving subunit 1323 is configured to receive second precommit results respectively transmitted by the plurality of target validator nodes; there being the second affirmative result for the proposal block in the plurality of second precommit results or there being a second negative result for the proposal block in the plurality of second precommit results.

The second counting subunit 1324 is configured to determine the quantity of second affirmative votes and the quantity of second negative votes for the proposal block according to the first precommit result and the plurality of second precommit results.

The precommit processing subunit 1325 is configured to, in a case that the quantity of second affirmative votes exceeds a first precommit threshold, determine that the first consensus result is a consensus pass result.

The precommit processing subunit 1325 is further configured to, in a case that the quantity of second negative votes exceeds a second precommit threshold, determine that the first consensus result is a consensus fail result.

For exemplary function implementations of the second determination subunit 1321, the second broadcasting subunit 1322, the second receiving subunit 1323, the second counting subunit 1324 and the precommit processing subunit 1325, reference can be made to specific description in the embodiment corresponding to FIG. 6b, and details will not be repeated herein.

Referring to FIG. 9 again, the block consensus apparatus 1 can further include: a second consensus module 15 and a second storage module 16.

The second consensus module 15 is configured to, in a case that the validity verification result of the proposal block is the invalid result, perform two rounds of consensus voting processing on the proposal block to obtain a second consensus result.

The second storage module 16 is configured to, in a case that the second consensus result is the consensus pass result, synchronize the proposal block, with the block height of M, that has been stored to the block chain from the completed validator node and the target contract execution result corresponding to the proposal block; the completed validator node being the target validator node that successfully stores the proposal block and the target contract execution result to the block chain.

For exemplary function implementations of the second consensus module 15 and the second storage module 16, reference can be made to specific description in the embodiment corresponding to FIG. 7, and details will not be repeated herein.

Referring to FIG. 9 again, the block verification module 11 can include: a successful acquisition unit 1151.

The successful acquisition unit 1151 is configured to, in response to acquiring the proposal block generated in the N^{th} round with the block height of M within a verification time threshold, perform validity verification on the proposal block.

The block consensus apparatus 1 can further include: a failed acquisition module 17, a third consensus module 18 and a third storage module 19.

The failed acquisition module 17 is configured to, in response to not acquiring the proposal block generated in the N^{th} round with the block height of M within the verification time threshold, construct a temporary empty block.

The third consensus module 18 is configured to perform two rounds of consensus voting processing on the temporary empty block to obtain a third consensus result.

The third storage module 19 is configured to, in a case that the third consensus result is the consensus pass result, synchronize the proposal block, with the block height of M, that has been stored to the block chain from the completed validator node and the target contract execution result corresponding to the proposal block; the completed validator node being the target validator node that successfully stores the proposal block and the target contract execution result to the block chain.

For exemplary function implementations of the successful acquisition unit 1151, the failed acquisition module 17, the third consensus module 18 and the third storage module 19, reference can be made to specific description in the embodiment corresponding to FIG. 7, and details will not be repeated herein.

Referring to FIG. 9 again, the block consensus apparatus 1 can further include: a first deleting module 110 and a second deleting module 111.

The first deleting module 110 is configured to delete the N contract execution results with the block height of M in the temporary list.

The second deleting module 111 is configured to acquire the total quantity of all the contract execution results in the temporary list, and in a case that the total quantity is greater than or equal to a stored quantity threshold, delete all the contract execution results in the temporary list; all the contract execution results including contract execution results respectively corresponding to one or more block heights.

For exemplary function implementations of the first deleting module 110 and the second deleting module 111, reference can be made to specific description in the embodiment corresponding to FIG. 8, and details will not be repeated herein.

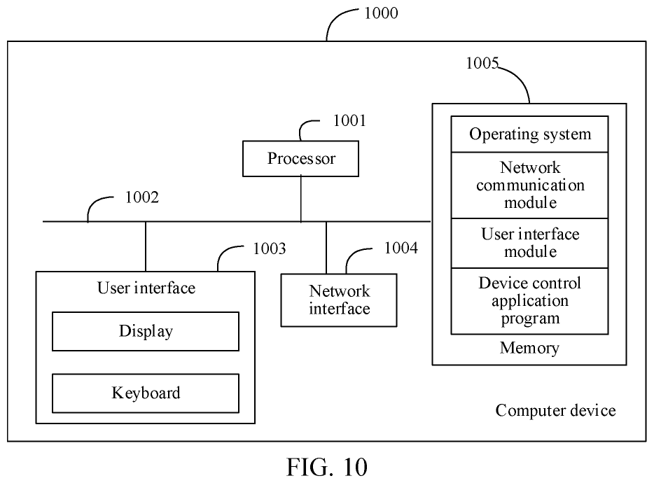

Referring to FIG. 10, FIG. 10 is a schematic structural diagram of a computer device provided by an embodiment of this disclosure. As shown in FIG. 10, the block consensus apparatus 1 in the embodiment corresponding to FIG. 9 can be applied to a computer device 1000, and the computer device 1000 can include: processing circuitry, such as a processor 1001, a network interface 1004 and a memory 1005. In addition, the computer device 1000 further includes: a user interface 1003 and at least one communication bus 1002. The communication bus 1002 is configured to implement connection and communication between the components. The user interface 1003 may include a display, a keyboard, and optionally, the user interface 1003 may further include a standard wired interface and a standard wireless interface. The network interface 1004 may include a standard wired interface and a standard wireless interface (such as a Wi-Fi interface). The memory 1005 may be a high-speed RAM memory, or may be a non-volatile memory, for example, at least one magnetic disk memory. The memory 1005 may further be at least one storage apparatus away from the foregoing processor 1001. As shown in FIG. 10, the memory 1005 used as a computer-readable storage medium may include an operating system, a network communication module, a user interface module, and a device-control application program.

In the computer device 1000 shown in FIG. 10, the network interface 1004 can provide a network communication function, and the user interface 1003 is mainly configured to provide an input interface for a user. The processor 1001 can be configured to call a device control application program stored in the memory 1005 to acquire a proposal block generated in an N^{th} round with a block height of M, M and N both being positive integers; execute transaction data in the proposal block through a smart contract to obtain a target contract execution result, and cache a block hash of the proposal block and the target contract execution result to a temporary list in an associated manner; the temporary list including N contract execution results with the block height of M, the N contract execution results including the target contract execution result; in a process of executing the transaction data through the smart contract, parallelly perform two rounds of consensus voting processing on the proposal block to obtain the first consensus result; and in a case that the first consensus result is a consensus pass result, acquire the target contract execution result mapped by the block hash of the proposal block in the temporary list, and store the proposal block and the target contract execution result to a block chain in the associated manner.

It is to be understood that the computer device 1000 described in this embodiment of this disclosure can implement the descriptions of the block chain-based block consensus method in the foregoing embodiment corresponding to FIG. 3, and can also implement the descriptions of the block chain-based block consensus apparatus 1 in the foregoing embodiment corresponding to FIG. 9. Details are not described herein again. In addition, the description of beneficial effects of the same method is not described herein again.

In addition, an embodiment of this disclosure further provides a computer-readable storage medium, such as a non-transitory computer-readable storage medium, and the computer-readable storage medium stores the computer program executed by the block chain-based block consensus apparatus 1 mentioned above. When loading and executing the computer program, the processor may perform the descriptions of the block chain-based block consensus method in any one of the foregoing embodiments. Therefore, details are not described herein again. In addition, the description of beneficial effects of the same method is not described herein again. For technical details that are not disclosed in the embodiments of the computer-readable storage medium of this disclosure, refer to the method embodiments of this disclosure.

The computer-readable storage medium may be a block consensus apparatus provided in any one of the foregoing embodiments or an internal storage unit of the computer device, for example, a hard disk or a main memory of the computer device. The computer-readable storage medium may alternatively be an external storage device of the computer device, for example, a removable hard disk, a smart memory card (SMC), a secure digital (SD) card, or a flash card equipped on the computer device. Further, the computer-readable storage medium may further include both an internal storage unit and an external storage device of the computer device. The computer-readable storage medium is configured to store the computer program and another program and data that are required by the computer device. The computer-readable storage medium may further be configured to temporarily store data that has been output or data to be output.

What is disclosed above is merely exemplary embodiments of this disclosure, and is not intended to limit the scope of this disclosure. Therefore, equivalent variations and other embodiments shall fall within the scope of this disclosure.

What is claimed is:

1. A block chain-based block consensus method, comprising:
acquiring a proposal block generated in an N^{th} round with a block height of M, and performing validity verification on the proposal block, M and N both being positive integers;
executing an application based on transaction data in the proposal block to obtain a target execution result, and store a block hash of the proposal block and the target execution result in a memory, the memory including N execution results with the block height of M, the N execution results including the target execution result;
while the application is executed based on the transaction data, performing two rounds of consensus voting processing on the proposal block to obtain a first consensus result; and
based on the first consensus result being a consensus pass result, acquiring the target execution result mapped by the block hash of the proposal block in the memory, and storing the proposal block and the target execution result to a block chain.

2. The method according to claim 1, wherein the executing the application based on the transaction data comprises:
based on a validity verification result of the validity verification performed on the proposal block being a valid result, executing the application based on the transaction data in the proposal block to obtain the target execution result.

3. The method according to claim 1, wherein the storing the block hash of the proposal block and the target execution result comprises:
storing the block hash of the proposal block and the target execution result as a key-value pair, the block hash of the proposal block being a key in the key-value pair and the target execution result being a value in the key-value pair.

4. The method according to claim 1, wherein the performing the validity verification comprises:
acquiring the transaction data in the proposal block, and performing a hash operation on the transaction data to obtain a to-be-verified hash value;
performing a hash operation on the to-be-verified hash value according to a Merkle tree path in the proposal block to obtain a to-be-verified tree root hash value;
acquiring a Merkle tree root hash value from a header of the proposal block;
based on the to-be-verified tree root hash value being identical with the Merkle tree root hash value, determining that a validity verification result of the validity verification performed on the proposal block is a valid result; and
based on the to-be-verified tree root hash value not being identical with the Merkle tree root hash value, determining that the validity verification result of the proposal block is an invalid result.

5. The method according to claim 1, wherein the performing the validity verification comprises:
acquiring the transaction data in the proposal block;
calling a transaction verification function to verify the transaction data to obtain a transaction verification result;
based on the transaction verification result being a valid result, determining that a validity verification result of the validity verification performed on the proposal block is a valid result; and
based on the transaction verification result being an invalid result, determining that the validity verification result of the proposal block is an invalid result.

6. The method according to claim 1, wherein the performing the validity verification comprises:
acquiring a block hash of a parent block of the proposal block in the block chain as a target parent block hash;
acquiring a parent block hash from a header of the proposal block as a to-be-verified parent block hash;
based on the to-be-verified parent block hash being identical with the target parent block hash, determining that a validity verification result of the validity verification performed on the proposal block is a valid result; and
based on the to-be-verified parent block hash not being identical with the target parent block hash, determining that the validity verification result of the proposal block is an invalid result.

7. The method according to claim 1, wherein the performing the validity verification comprises:
acquiring signature data associated with the proposal block;
acquiring a public key of a proposer node, and verifying the signature data through the public key to obtain a signature verification result;
based on the signature verification result indicating successful signature verification, determining that a validity verification result of the validity verification performed on the proposal block is a valid result; the signature data with the successful signature verification being obtained by signing, by the proposer node, the proposal block through a possessed private key, and the proposal block associated with the signature data with the successful signature verification being generated by the proposer node; and
based on the signature verification result indicating failed signature verification, determining that the validity verification result of the proposal block is an invalid result.

8. The method according to claim 1, wherein
the executing the application based on the transaction data comprises:
acquiring the transaction data in the proposal block, and calling a transaction execution function configured to execute the transaction data in the application,
acquiring read data of the transaction data according to the transaction execution function, and
executing the transaction execution function according to the read data and the transaction data to obtain the target execution result of the transaction data; and
the storing the block hash of the proposal block and the target execution result includes storing the block hash of the proposal block and the target execution result in the memory in an associated manner.

9. The method according to claim 1, wherein the performing the two rounds of the consensus voting processing comprises:
in a first round of the consensus voting, performing prevote processing on the proposal block according to a validity verification result of the validity verification performed on the proposal block to obtain a prevote result; and
in a second round of the consensus voting, performing precommit processing on the proposal block according to the prevote result to obtain the first consensus result.

10. The method according to claim 9, wherein the performing the prevote processing comprises:
in the first round of the consensus voting, determining a first prevote result as a first affirmative result for the proposal block according to the valid result;
broadcasting the first prevote result to a plurality of target validator nodes;
receiving second prevote results respectively from the plurality of target validator nodes, the plurality of second prevote results including at least one of the first affirmative result for the proposal block or a first negative result for the proposal block;
determining a quantity of first affirmative votes and a quantity of first negative votes for the proposal block according to the first prevote result and the plurality of second prevote results;
based on the quantity of first affirmative votes exceeding a first prevote threshold, determining that the prevote result is a successful prevote result; and
based on the quantity of first negative votes exceeding a second prevote threshold, determining that the prevote result is a failed prevote result.

11. The method according to claim 10, wherein the performing the precommit processing comprises:
based on the prevote result being the successful prevote result, determining a first precommit result as a second affirmative result for the proposal block;
based on the prevote result being the failed prevote result, determining the first precommit result as a second negative result for the proposal block;
broadcasting the first precommit result to the plurality of target validator nodes;
receiving second precommit results respectively from the plurality of target validator nodes, the plurality of second precommit results including at least one of the second affirmative result for the proposal block or the second negative result for the proposal block;
determining a quantity of second affirmative votes and a quantity of second negative votes for the proposal block according to the first precommit result and the plurality of second precommit results;
based on the quantity of second affirmative votes exceeding a first precommit threshold, determining that the first consensus result is the consensus pass result; and
based on the quantity of second negative votes exceeding a second precommit threshold, determining that the first consensus result is a consensus fail result.

12. The method according to claim 1, further comprising:
based on a validity verification result of the validity verification performed on the proposal block being an invalid result, performing two rounds of consensus voting processing on the proposal block to obtain a second consensus result; and
based on the second consensus result being the consensus pass result, synchronizing the proposal block, with the block height of M, that has been stored to the block chain from a target validator node and the target execution result corresponding to the proposal block, the target validator node successfully storing the proposal block and the target execution result to the block chain.

13. The method according to claim 1, wherein the performing the validity verification comprises:
in response to acquiring the proposal block generated in the N^{th} round with the block height of M within a verification time threshold, performing the validity verification on the proposal block;
the method further comprising:
in response to not acquiring the proposal block generated in the N^{th} round with the block height of M within the verification time threshold, constructing a temporary empty block;
performing two rounds of consensus voting processing on the temporary empty block to obtain a third consensus result; and
based on the third consensus result being the consensus pass result, synchronizing the proposal block, with the block height of M, that has been stored to the block chain from a target validator node and the target execution result corresponding to the proposal block, the target validator node successfully storing the proposal block and the target execution result to the block chain.

14. The method according to claim 1, wherein after the storing the proposal block and the target execution result to the block chain, the method further comprises:
deleting the N execution results with the block height of M in the memory; or
acquiring a total quantity of all the execution results in the memory, and based on the total quantity being greater than or equal to a stored quantity threshold, deleting all the execution results in the memory; all the execution results corresponding to one or more block heights.

15. A block chain-based block consensus apparatus, the apparatus comprising:
processing circuitry configured to:
acquire a proposal block generated in an N^{th} round with a block height of M, and perform validity verification on the proposal block, M and N both being positive integers;
execute an application based on transaction data in the proposal block to obtain a target execution result, and store a block hash of the proposal block and the target execution result in a memory, the memory including N execution results with the block height of M, the N execution results including the target execution result;
while the application is executed based on the transaction data, perform two rounds of consensus voting processing on the proposal block to obtain a first consensus result; and
based on the first consensus result being a consensus pass result, acquire the target execution result mapped by the block hash of the proposal block in the memory, and store the proposal block and the target execution result to a block chain.

16. The block chain-based block consensus apparatus according to claim 15, wherein the processing circuitry is configured to:
based on a validity verification result of the validity verification performed on the proposal block being a valid result, execute the application based on the transaction data in the proposal block to obtain the target execution result.

17. The block chain-based block consensus apparatus according to claim 15, wherein the processing circuitry is configured to:
store the block hash of the proposal block and the target execution result in the memory as a key-value pair, the block hash of the proposal block being a key in the key-value pair and the target execution result being a value in the key-value pair.

18. The block chain-based block consensus apparatus according to claim 15, wherein the processing circuitry is configured to:
acquire the transaction data in the proposal block, and perform a hash operation on the transaction data to obtain a to-be-verified hash value;
perform a hash operation on the to-be-verified hash value according to a Merkle tree path in the proposal block to obtain a to-be-verified tree root hash value;
acquire a Merkle tree root hash value from a header of the proposal block;
based on the to-be-verified tree root hash value being identical with the Merkle tree root hash value, determine that a validity verification result of the validity verification performed on the proposal block is a valid result; and
based on the to-be-verified tree root hash value not being identical with the Merkle tree root hash value, determine that the validity verification result of the proposal block is an invalid result.

19. The block chain-based block consensus apparatus according to claim 15, wherein the processing circuitry is configured to:
acquire the transaction data in the proposal block;
call a transaction verification function to verify the transaction data to obtain a transaction verification result;
based on the transaction verification result being a valid result, determine that a validity verification result of the validity verification performed on the proposal block is a valid result; and
based on the transaction verification result being an invalid result, determine that the validity verification result of the proposal block is an invalid result.

20. A non-transitory computer-readable storage medium, storing instructions which when executed by a processor cause the processor to perform:
acquiring a proposal block generated in an N^{th} round with a block height of M, and performing validity verification on the proposal block, M and N both being positive integers;
executing an application based on transaction data in the proposal block to obtain a target execution result, and store a block hash of the proposal block and the target execution result in a memory, the memory including N execution results with the block height of M, the N execution results including the target execution result;
while the application is executed based on the transaction data, performing two rounds of consensus voting processing on the proposal block to obtain a first consensus result; and
based on the first consensus result being a consensus pass result, acquiring the target execution result mapped by the block hash of the proposal block in the memory, and storing the proposal block and the target execution result to a block chain.
